(19) United States
(12) Patent Application Publication
(10) Pub. No.: US 2025/0378456 A1
(43) Pub. Date: Dec. 11, 2025

(54) AI-Driven Autonomous System for International Market Entry Strategy Formulation in FMCG

(71) Applicant: Lourdes Cuevas Madrazo, Barcelona (ES)

(72) Inventor: Lourdes Cuevas Madrazo, Barcelona (ES)

(21) Appl. No.: 19/312,974

(22) Filed: Aug. 28, 2025

(51) Int. Cl. G06Q 30/0201; G06Q 30/0202

(52) U.S. Cl. CPC G06Q 30/02017; G06Q 30/0202; G06Q 30/0206

(57) ABSTRACT

The present invention relates to an AI-driven platform for automatically generating an international market entry strategy for Fast-Moving Consumer Goods (FMCG) products. The platform comprises multiple integrated modules including a data ingestion module for acquiring and normalizing data from diverse sources, a demand forecasting module that leverages machine learning to predict market-specific demand and a pricing optimization module that computes retail prices based on landed cost, competitive pricing and consumer purchasing power. Additionally, the platform includes a distribution recommendation module, a benchmarking module for strategy validation against historical patterns and an output module that compiles the final strategy report. The invention provides a scalable and automated solution for companies seeking data-driven expansion into new markets, reducing time, effort and subjectivity in decision-making. The scope extends across industries seeking automated, intelligent tools for global market entry planning.

### TECHNICAL FIELD

The present invention relates to the field of artificial intelligence-based business analytics systems, and more particularly to an AI-driven autonomous system that enables FMCG manufacturers to formulate and execute international market entry strategies with accuracy and efficiency.

### BACKGROUND

The background description includes information that may be useful in understanding the present invention. It is not an admission that any of the information provided herein is prior art or relevant to the presently claimed invention, or that any publication specifically or implicitly referenced is prior art.

Traditionally, entering foreign markets has been a complex and resource-intensive undertaking for manufacturers of fast-moving consumer goods (FMCG) which include items such as food, beverages, personal care products and household consumables. The products operate on thin profit margins and require high sales volumes to be profitable, making accurate planning and cost control critical when expanding internationally. When an FMCG company seeks to introduce its products into a new country, it must navigate a multitude of variables that includes import tariffs, customs duties, international shipping costs, local regulations, competitor pricing, consumer preferences and the availability and effectiveness of local distribution channels. Each of these factors can differ significantly between countries and even small miscalculations in pricing, logistics or market approach can result in failed product launches or eroded profit margins.

To address the complexities, FMCG companies have historically relied on manual processes and fragmented systems involving various domain experts. For instance, a trade compliance specialist might be consulted to determine tariff codes and applicable duties based on the Harmonized System (HS), a logistics planner is tasked with estimating freight costs and shipping times, a marketing team would research local consumer preferences and competitor prices and business development professionals would work to identify potential distributors or retailers. The activities are often siloed, handled by different departments or consultants using disconnected tools such as spreadsheets, online databases and market reports. This fragmented labour-intensive approach consumes valuable time and resources and often lacks the cohesion necessary for forming a truly optimized market entry strategy.

Moreover, traditional methods struggle to account for dynamic market conditions. Tariffs and trade agreements are subject to frequent change, shipping costs fluctuate based on fuel prices and global logistics disruptions and local market conditions can shift rapidly due to seasonality, political developments or consumer trends. Manual research and static tools cannot easily adapt to such variability in real time. Even larger firms with specialized teams can find it difficult to process and interpret the constantly evolving data effectively, while smaller and mid-sized manufacturers who may lack in-house expertise or the budget for consultants are often left at a significant disadvantage when trying to enter international markets.

While there have been advancements in isolated areas such as AI tools for demand forecasting or pricing optimization within single markets there remains a significant gap in the availability of an integrated, intelligent solution for end-to-end international market entry planning. Barcode data, particularly GTIN (Global Trade Item Number) identifiers, offers a standardized way to classify and retrieve product category information globally. However, this valuable data is rarely connected automatically to logistics, tariff or market insights in current tools. Likewise, while tariff and freight cost data may be accessible through APIs or public databases, applying the data points meaningfully to pricing or distribution decisions still requires human interpretation.

To address the above limitations, there is a pressing need for a unified, automated system that can integrate all relevant data sources and intelligently generate market entry strategies with minimal manual intervention. The growing complexity of global trade coupled with the need for rapid decision-making and cost optimization calls for a solution that not only aggregates diverse datasets but also applies machine learning to uncover patterns, make predictions and recommend actionable strategies. Such a system would dramatically reduce the time, cost and uncertainty associated with international expansion, particularly for FMCG manufacturers operating under tight margins and high competitive pressure.

### SUMMARY

The present invention relates to an AI-driven autonomous system configured to enable fast-moving consumer goods (FMCG) manufacturers to efficiently formulate and execute international market entry strategies. The system comprises multiple integrated modules including a data ingestion module for receiving and normalizing data from various sources, a demand forecasting module that uses machine learning to predict product demand in target markets and a price optimization module that calculates optimal retail pricing based on factors such as landed cost, competitive pricing, consumer purchasing power, and business objectives. The system integrates these modules into an AI-driven platform. Unlike conventional tools that are fragmented and heavily reliant on manual input, the invention employs specialized autonomous AI agents that interact with curated, proprietary datasets to generate, simulate and validate market entry roadmaps with minimal human interventions. This approach reduces decision-making time from weeks to hours, minimizes the risk of entry failure and improves resource allocation efficiency. The invention offers several advantages that includes increased speed and accuracy in market strategy development, reduced reliance on human expertise, scalability across multiple regions and products and improved alignment of pricing and distribution with market conditions. The scope of the invention spans to a wide range of FMCG categories and international markets, offering strategic insights for new product launches, market expansion and competitive positioning.

In an embodiment of the present invention, the invention discloses an AI-driven platform for automatically generating an international market entry strategy for a FMCG product. The platform comprising an data ingestion module configured to receive and normalize data from a plurality of data sources, a demand forecasting module configured to predict product demand in a target market using a machine learning model and a price optimization module configured to compute a recommended retail price based on landed cost, competitive pricing data, consumer purchasing power and manufacturer-defined objectives. The platform also includes a distribution module configured to recommend at least one distribution channel based on product and market data, a benchmarking module configured to validate and refine the price and distribution strategy against historical benchmarks and product-market patterns using statistical analysis or anomaly detection techniques. An output module configured to generate a report presenting the validated price, distribution strategy, key metrics and benchmarking insights to support market entry decisions. The platform operates autonomously upon receiving input from ingestion data module to generate a data-driven, market-specific strategy without requiring manual analysis or intervention.

In one of the embodiments of the present invention, the data ingestion module is configured to retrieve and normalize data from the plurality of data sources including product data, tariff and customs data, shipping and logistics data and distribution channel data.

In one of the embodiments of the present invention, the demand forecasting module employs a machine learning model selected from regression models, neural networks or decision trees to forecast demand.

In one of the embodiments of the present invention, the demand forecasting module utilizes historical sales data, macroeconomic indicators, seasonality trends and market segmentation data to predict demand for the product in the target market.

In one of the embodiments of the present invention, the price optimization module calculates the recommended retail price by combining landed cost with regional purchasing power indices, competitive pricing data, and desired profit margins.

In one of the embodiments of the present invention, the price optimization module adjusts the recommended price based on the manufacturer's objective to maximize profit, enhance market penetration or position the product as a premium offering.

In one of the embodiments of the present invention, the distribution module selects the distribution strategy based on infrastructure, consumer behaviour and historical channel success in the target region.

In one of the embodiments of the present invention, the distribution module is configured to recommend distribution channels selected from local distributors, retail chains, e-commerce platforms or hybrid combinations thereof.

In one of the embodiments of the present invention, the benchmarking module compares the generated strategy against historical benchmarks using anomaly detection algorithms to identify outliers in price or distribution decisions.

In one of the embodiments of the present invention, the benchmarking module validates the strategy by referencing region-specific success rates, pricing tolerances and distribution channel performance metrics.

In one of the embodiments of the present invention, the report generated by the output module includes predictive metrics such as estimated first-quarter sales, projected market share and return on investment.

In one of the embodiments of the present invention, the output module presents the strategy report via a user interface or exportable file format incorporating charts, key performance indicators and scenario-based recommendations.

In one of the embodiments of the present invention, the platform supports real-time re-evaluation of strategy when updated input data is received including tariff rate changes, logistics delays or inventory fluctuations.

In another embodiment of the present invention, the invention discloses a method for generating an international market entry strategy for a FMCG product. The method comprising ingesting and normalizing product, market and logistics data from multiple data sources, forecasting demand in a target market using a machine learning model, optimizing price based on landed cost, competitive pricing, consumer purchasing power and business objectives. The method also includes recommending distribution channels using product-market analysis and historical outcomes and validating and outputting a market entry strategy report including pricing, distribution and benchmarking insights.

In one of the embodiments of the present invention, the ingesting and normalizing data includes retrieving standardized product information using GS1 or similar GTIN codes and mapping product categories to corresponding Harmonized System (HS) tariff codes.

In one of the embodiments of the present invention, the optimizing price includes calculating the landed cost as a sum of manufacturing cost, shipping fees, import duties, and customs clearance charges.

In one of the embodiments of the present invention, validating the strategy includes comparing the optimized price and selected distribution channel against historical benchmarks using anomaly detection techniques to identify deviations from market norms.

In one of the embodiments of the present invention, recommending distribution channels includes selecting atleast one of the local distributors, e-commerce platforms or retail chains based on a machine learning model trained on historical market entry outcomes.

In one of the embodiments of the present invention, the machine learning models used in the forecasting, pricing and distribution steps are dynamically updated based on new market data or feedback from past market entry outcomes.

In one of the embodiments of the present invention, the output strategy report includes a projected sales volume and estimated profit margin for the recommended retail price and distribution channel in the target market.

For further clarification of the features and other embodiments of the invention, a more particular description is provided that will further explain the features and advantage of the invention with the illustration or the drawings. As will be appreciated, other embodiments of the present invention are possible utilizing, alone or in combination, one or more of the features set forth above or described in detail below.

### BRIEF DESCRIPTION OF THE DRAWINGS

A full understanding of the invention can be gained from the following description of the preferred embodiments when read in conjunction with the accompanying drawings in which:

FIG. 1 illustrates a block diagram of an AI-driven platform configured for generating an international market entry strategy for a fast-moving consumer goods (FMCG) product, in according to embodiments of the present invention disclosed herein.

FIG. 2 illustrates a method of operating an AI-driven platform, in according to embodiments of the present invention disclosed herein.

FIG. 3 illustrates a block diagram of a computer-implemented system for generating an international marketing strategy for fast moving consumer goods (FMCG) products, in according to embodiments of the present invention disclosed herein.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

References will now be made in detail to the presently preferred embodiments of the invention, examples of which are illustrated in the accompanying drawings. Throughout the following detailed description, the same reference numerals refer to the same elements in all figures.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and it is not intended to be limiting the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the following description, reference will be made to the accompanying drawing, in which comparable functional elements are designated with like numerals. The aforementioned accompanying drawings show by way of illustration and not by the way of limitation, specific aspects and implementations consistent with principles of this disclosure. These implementations are described in sufficient detail to enable those skilled in the art to practice the disclosure and it is to be understood that other implementations may be utilized, and that structural changes and/or substitutions of various elements may be made without departing from the scope and spirit of this disclosure. The following detailed description is, therefore, not to be construed in limited sense. It is noted that description herein is not intended as an extensive overview, and as such, concepts may be simplified in the interests of clarity and brevity. All documents mentioned in this application are hereby incorporated by reference in their entirety.

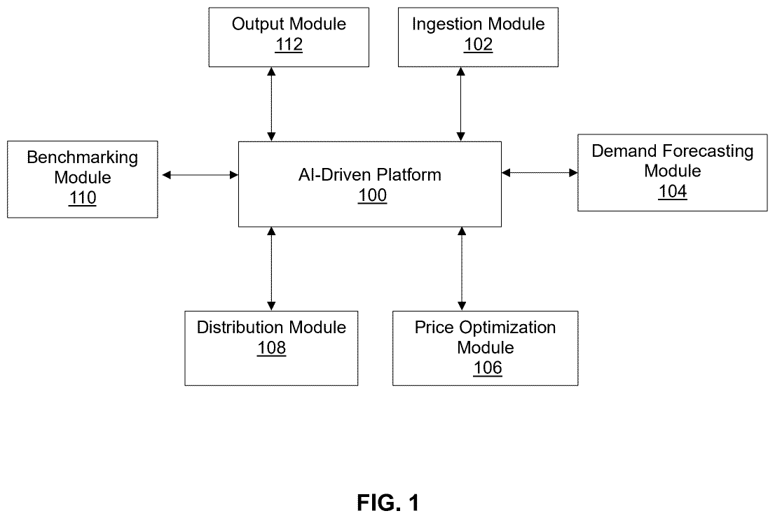

According to the embodiment of the present invention, the invention discloses an AI-driven platform to autonomously generate an international market entry strategy for a fast-moving consumer goods (FMCG) product as shown by FIG. 1. The platform 100 comprises a data ingestion module 102 configured to retrieve, aggregate and normalize data from a variety of internal and external sources. This includes product-specific data (e.g., product name, category, unit cost, Global Trade Item Number (GTIN), and physical attributes) as well as supply chain variables such as current inventory, production capacity and intended export volumes. The system uses GTIN or other unique product identifiers to fetch additional standardized product information such as Global Product Classification (GPC) codes and other metadata from global registries. The data ingestion module 102 further interfaces with customs and tariff databases to identify the applicable Harmonized System (HS) code for the product and fetches corresponding tariff rates, import duties, non-tariff barriers and other regulatory requirements of the target market. Simultaneously, the platform accesses shipping logistics data (e.g., freight rates, fuel surcharges, handling costs and estimated transit time) via API connections to global logistics providers or freight databases. The data inputs are used to compute the landed cost of the product using the following formula:

Landed Cost=Base Product Cost+Tariff/Duties+Shipping Cost+Clearing and Handling Expenses

This calculated landed cost forms a critical input for the downstream pricing strategy. Additionally, the data ingestion module 102 gathers information on distribution channel options within the target market such as distributors, wholesalers, retail chains and e-commerce platforms including their associated costs, regional coverage, constraints (e.g., minimum order volumes) and historical performance data. It also incorporates retail pricing norms, channel-specific margins and retailer fee structures. The output of the data ingestion module 102 is passed to a demand forecasting module 104 which applies a machine learning algorithms such as a regression model, neural network or decision tree to predict demand for the product in the target market. Inputs to the demand forecasting module 104 include historical sales data (if available), macroeconomic indicators, market segmentation data, seasonality effects and purchasing power indices. The result is an estimated sales forecast which is used to guide pricing and distribution decisions. In the embodiment, a price optimization module 106 is configured to determine the optimal retail price of the product for the target market. The price optimization module 106 uses the computed landed cost, local purchasing power, competitor pricing data, expected retail markups and the manufacturer's stated business objectives (e.g., market penetration, profit maximization, or premium positioning). The price optimization module 106 incorporates machine learning models trained on past pricing strategies and outcomes across multiple markets. For instance, the platform may recommend a slightly undercut price compared to competitors in order to drive initial adoption while maintaining acceptable margins above the landed cost. In parallel, the distribution module 108 evaluates potential market entry channels using another machine learning model such as a classification or ranking algorithm. The distribution module 108 takes into account the product's logistical needs, market-specific retail behaviours, historical distribution effectiveness and cost-to-margin ratios. The distribution module 108 recommends a single-channel or hybrid strategy for example, a mix of retail distribution via a national wholesaler combined with listing on an e-commerce platform. The platform ensures that the selected distribution channel is compatible with the recommended pricing strategy, taking into account margins, operational constraints and reach. Once price and distribution recommendations are generated, a benchmarking module 110 performs validation by comparing the proposed strategy against historical market data and success patterns for similar product entries. The benchmarking module utilizes statistical comparison, rule-based logic or anomaly detection algorithms to detect outliers or deviations. For example, if the proposed retail price is more than 20% above the market average for similar products, the benchmarking module 110 flags it for review or re-tunes the pricing recommendation. Likewise, if the suggested distribution approach has historically underperformed for the product category, the module may adjust or annotate the recommendation. In the embodiment, an output module 112 generates a comprehensive strategy report. The report presents the validated price, recommended distribution channel(s), key forecasting metrics such as projected market share, estimated first-quarter sales, expected ROI and benchmarking insights. The report can be rendered via a graphical user interface (GUI) or exported in various file formats. The output may include visual elements such as pricing graphs, confidence intervals, cost breakdown charts and channel performance comparisons.

In one of the embodiments of the present invention, the platform also supports real-time strategy re-evaluation. If the platform receives updated inputs such as revised tariff rates, shipping cost changes or inventory fluctuations, it can automatically reprocess the data through the pipeline to produce a refreshed strategy output.

In one of the embodiments of the present invention, the pricing optimization module calculates a recommended retail price using machine learning models trained on historical data. It considers factors such as landed cost, competitor pricing, purchasing power, and retail markups. The module also accounts for macroeconomic indicators and user-defined business goals (e.g., profit maximization or market penetration). Using models like regression or neural networks, it outputs a price or price range that balances profitability with market competitiveness.

In one of the embodiments of the present invention, the distribution channel recommendation module leverages a trained classification or ranking algorithm to identify the most effective routes to market for the product based on contextual and product-specific parameters. The parameters include product category, shelf-life, packaging requirements, and any logistical constraints such as cold chain needs or unit volume. The module incorporates performance history of those channels such as sales conversion rates, geographic coverage and historical success with similar products. In the embodiment, the module evaluates the cost-to-margin ratio for each candidate channel, considering associated distributor fees, retailer commissions and onboarding costs. The module output a ranked list of preferred channels, a recommended hybrid approach or specific partnerships (e.g., “Partner with Distributor X and list on Platform Y”) with justifications based on empirical market success data and compatibility with the selected pricing strategy.

In one of the embodiments of the invention, the benchmarking module serves as a strategy validation and refinement component by comparing the initially generated price and distribution recommendations against historical benchmarks and market norms. The module employs rule-based systems and optionally anomaly detection algorithms trained to flag outlier decisions that deviate significantly from successful historical patterns. For instance, it may identify a recommended price that exceeds the standard deviation of average market pricing for that product class, or a distribution channel strategy that has underperformed historically in similar contexts. In the embodiment, the benchmarking module accesses region-specific data including competitor price ranges, sales performance of analogous products and distribution channel effectiveness metrics. Based on this analysis, the module may prompt automated adjustments to the pricing or distribution recommendation or annotate the final report with cautionary or explanatory notes.

In one of the embodiments of the present invention, the output module presents scenario-based simulations (e.g., “What-if” analyses) that show how the strategy would perform under different market conditions such as tariff rate increases or logistics delays. The module also supports versioning or strategy comparison, enabling iterative refinement and data-driven decision-making.

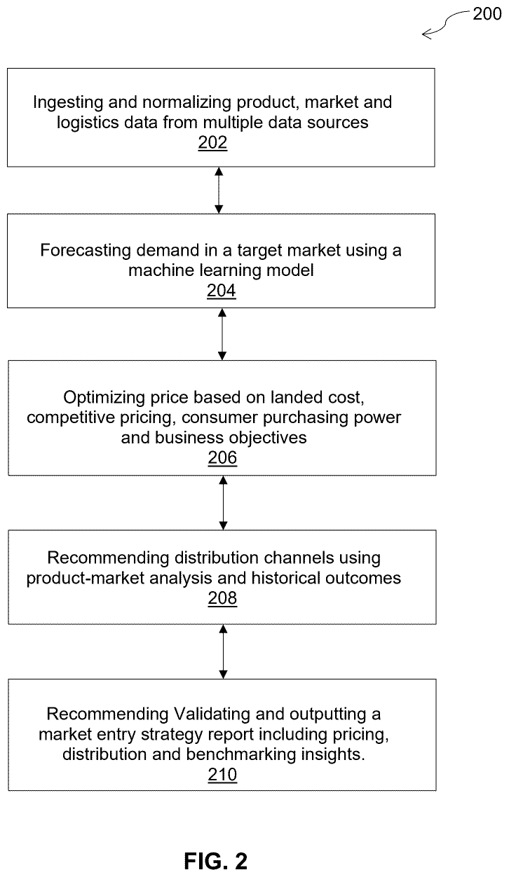

Referring to FIG. 2, the invention discloses a method for autonomously generating an international market entry strategy for a fast-moving consumer goods (FMCG) product using an AI-driven decision support platform. The method 200 begins with a data ingestion and normalization where the platform collects input data from multiple sources, including user-provided product details, standardized global databases, trade registries, and logistics platforms as shown by step 202. This data includes product attributes, GTIN codes, production costs and intended markets. The platform automatically retrieves additional metadata by mapping GTINs to corresponding Global Product Classification (GPC) and Harmonized System (HS) tariff codes. The ingestion process also incorporates real-time shipping costs, customs fees and applicable regulatory information which are normalized and aggregated into a unified data structure suitable for machine learning processing. Once data is normalized, the method 200 proceeds to demand forecasting where a machine learning model such as a regression model, decision tree, or neural network is employed to predict product demand in the selected target market as shown by step 204. This forecast leverages historical sales data, seasonality trends, macroeconomic indicators and consumer segmentation information. By analyzing this multi-dimensional data, the model produces a demand estimate that informs downstream pricing and distribution decisions. In the embodiment, in step 206, the method 200 includes a price optimization process. Here, the platform calculates the landed cost of the product by summing the base manufacturing cost, international shipping charges, import tariffs and duties and customs clearance fees. This landed cost acts as the financial floor upon which the recommended retail price is built. The price optimization module considers additional factors including competitive product pricing, local purchasing power indices, typical retail markup percentages and user-defined business goals such as maximizing profit, expanding market share or premium brand positioning. Using one or more trained machine learning algorithms, the module outputs an optimal retail price or price range, balancing profitability and market alignment. In the embodiment, the method 200 performs distribution channel recommendation as shown by step 208. A classification or ranking model trained on historical market entry data assesses the most effective route(s) to market based on product type, logistical constraints, regional consumer behaviour and available infrastructure. The model selects the channel or combination of channels expected to yield the greatest reach and return on investment, factoring in associated distribution fees, listing requirements and channel-specific margin expectations. Once the pricing and distribution strategies are proposed, the method 200 executes a strategy validation and generation of market entry report as shown by step 210. This step involves comparing the generated recommendations against historical benchmarks using statistical techniques and anomaly detection algorithms. The report is prepared by the output module and delivered via a user interface or exportable file format (e.g., PDF or Excel). It includes the recommended retail price, selected distribution channels and a detailed breakdown of the cost structure. Additionally, the report presents projected metrics such as estimated first-quarter sales volume, expected profit margins and return on investment. It may also include benchmarking insights or risk annotations such as confidence scores or comparative pricing visuals.

In one of the embodiments of the present invention, the pseudocode below provides the logical flow utilized by the platform for carrying out it tasks. The pseudo code includes:

```
INPUT: ProductInfo, TargetMarket
OUTPUT: MarketEntryStrategy
1. // Data Ingestion
2. Retrieve product details and supply chain data from ProductInfo.
3. If ProductInfo contains a GS1 or similar GTIN:
    Look up GS1 or similar database for product category and attributes.
4. Determine HS tariff code and query tariff database for TargetMarket duty rates.
5. Query logistics database for shipping cost and transit info.
6. Retrieve distribution channel data for TargetMarket (available distributors, retailers,
online platforms).
7. Compute LandedCost = ProductCost + TariffCost + ShippingCost.
8. // Pricing Optimization using ML
9. optimal_price: = PricingModel.predictOptimalPrice(ProductInfo, LandedCost,
TargetMarket, market_data).
10. // Distribution Recommendation using ML
11. optimal_channel: = DistributionModel.recommendChannel(ProductInfo,
TargetMarket, channel_data)
12. // Benchmarking and Adjustment
13. benchmark_result: = BenchmarkModule.compareAgainstMarket(optimal_price,
optimal_channel, ProductInfo, TargetMarket).
14. If suboptimal:
  Adjust optimal_price or optimal_channel.
15. // Output Strategy Construction
16. strategy: = ConstructStrategyReport(optimal_price, optimal_channel, LandedCost,
benchmark_result.notes).
17. RETURN MarketEntryStrategy = strategy.
```

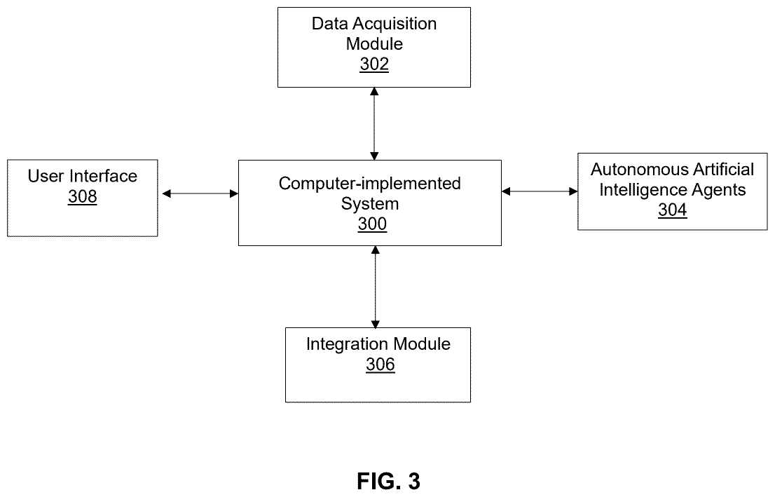

Referring to FIG. 3, the invention discloses a computer-implemented system 300 for generating an international marketing strategy for fast moving consumer goods (FMCG) products. The system 300 includes a data acquisition module 302 which is configured to retrieve and normalize the data from a plurality of data sources. These data sources include, but not limited to, tariff schedule, regulatory compliance requirements, logistics and transportation parameters, retail market intelligence, consumer demand forecast and competitive landscape insights. The data acquisition module 302 ensures that the incoming data regardless of its origin or format is standardized and pre-processed for downstream analysis by the AI agents. In the embodiments, a plurality of autonomous artificial intelligence agents 304 trained and configured to process a specific functional subset of the ingested data. For instance, one agent may specialize in tariff and regulatory analysis, while another focuses on demand forecasting suing historical sales and economic indicators. Other agents address competitive benchmarking, pricing strategy or distribution marketing. These AI agents 304 operate in parallel, leveraging proprietary machine learning algorithms and domain-specific training datasets to autonomously extract insights, simulate scenarios and generate functional recommendations. In the embodiments, the AI agents 304 are trained on the proprietary dataset comprising over 650 historical FMCG market entry cases, allowing them to make highly contextualized and reliable predictions across diverse market conditions. The outputs are generated by each AI agent 304 are transmitted to an integration module 306 which is configured to aggregate the insights and recommendations from the various agents and resolves any conflicts or overlaps to forma unified coherent market entry strategy. The strategy includes proposed product launch timelines, region-specific pricing guidelines, distribution channel recommendations, regulatory risk assessments and logistical planning. The integration module 304 also rank market based on opportunity potential, cost of entry and strategic alignment with business objectives. In the embodiment, a user interface 308 is provided to present the resulting strategy to a human decision-maker in an actionable format. The UI 308 is configured to display dashboards, data visualizations, interactive reports and scenario comparisons. The system 300 is configured to work with full autonomy after initial input parameters are provided. This allows the platform to reduce decision-making time from several weeks to a matter of hours, while ensuring consistency in the strategic recommendations.

In one of the embodiments of the present invention, the system utilizes a data acquisition layer configured to continuously harvest structured and unstructured datasets from diverse sources such as custom databases, GS1 or similar registries, trade associations, retailer procurement feeds and social sentiment platform. Further, the system includes a pre-processing engine that performs data cleansing, normalization and enrichment using natural language processing and entity recognition models. An autonomous agent layer which includes the plurality of AI agents for example a tariff agent that retrieves and interprets HS code-specific tariff schedule and calculates landed cost scenarios, a regulatory compliance agent that processes import regulations and product labelling requirements, a retail intelligence agent that analyses SKU-Level pricing, shelf presence and category trend in retail environments, a logistics optimization agent that stimulates distribution and warehousing scenarios based on cost and efficiency metrics and a market feasibility agent that synthesises the outputs into strategic recommendations from market entry, pricing and promotion timings. Further, the user interface for showcasing the strategic results.

In one of the embodiments of the present invention, the platform is employed by a small-to-medium enterprise (SME) based in Spain that specializes in producing olive oil, seeking to expand its operations into the United States market. The SME accesses the platform via the graphical user interface (GUI) provided by the system and initiates the market entry strategy generation process by submitting key input parameters including product category (“Olive oil (FMCG food)”), target export market (“United States”), the applicable Harmonized System (HS) code (1509), available annual production capacity (5,000 liters) and a target wholesale price point of €4.20 per liter. Upon receiving this input, various intelligent agents within the system are activated in orchestration. The Tariff & Regulatory Agent interfaces with harmonized tariff schedule databases and U.S. Food and Drug Administration (FDA) import alert systems to determine that the selected product category is subject to a 9.8% ad valorem import duty along with mandatory FDA registration and product labelling compliance. Simultaneously, the Logistics Agent queries international freight databases and shipping APIs to estimate the cost of transporting olive oil in 20-foot containers from Valencia, Spain to New Jersey, United States. The shipping cost is determined to fall within a range of $2,500 to $3,000 per container inclusive of customs clearance and handling fees. The Benchmarking Agent conducts comparative analysis by scraping retail and wholesale pricing data from major U.S. distribution and retail platforms such as walmart, whole foods and target. It identifies an average U.S. wholesale market price for imported olive oil at approximately $5.80 per liter. Additionally, the Buyer Network Agent queries a proprietary database of verified international trade leads and identifies three pre-qualified U.S. distributors with a history of Mediterranean food imports and existing demand for premium olive oil products. Upon synthesis of this multi-source intelligence, the platform automatically generates a comprehensive market entry strategy report. The report includes a detailed cost breakdown indicating an estimated landed cost of €5.05 per liter which factors in the base production cost, tariffs shipping, customs clearance and handling. Based on competitive benchmarking and the manufacturer's target margin objectives, the price optimization module recommends a wholesale entry price of €6.20 per liter to secure a 20% gross margin. The report also outlines necessary regulatory steps including FDA facility registration and compliance with U.S. food labelling standards. Furthermore, it provides contact information for the three U.S. distributors identified as potential partners. The platform's automated feedback loop detects a potential risk of margin compression given that the landed cost is closely aligned with the market average wholesale price. In response, the benchmarking module flags this concern and offers corrective recommendations such as exploring alternative logistics routes (e.g., consolidated shipping through Mexico to reduce freight costs) or evaluating secondary target markets like Canada where import tariffs for olive oil are lower. All insights and outputs are rendered within the GUI and are optionally exportable in PDF format for executive review or external sharing.

It should be understood that the examples provided herein are intended only for purposes of illustration and any number of other implementations is also contemplated. Additionally, the referenced examples (including the described rules and/or other techniques) can be combined in any number of ways.

Although an overview of the inventive subject matter has been described with reference to specific example implementations, various modifications and changes can be made to those implementations without departing from the broader scopes of implementation of the present disclosure. Such implementation of the inventive subject matter can be referred to herein, individually or collectively, by the term “invention” merely for convenience without intending to voluntarily limit the scope of this application to any single disclosure or inventive concept if more than one is, in fact is disclosed.

The implementations illustrated herein are described in sufficient detail to enable those skilled in the art to practice the teachings disclosed. Other implementations can be used and derived therefrom, such that structural substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources or structures described herein as a single instance. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. An AI-driven platform for automatically generating an international market entry strategy for a FMCG product, the platform comprising:
a data ingestion module configured to receive and normalize data from a plurality of data sources;
a demand forecasting module configured to predict product demand in a target market using a machine learning model;
a price optimization module configured to compute a recommended retail price based on landed cost, competitive pricing data, consumer purchasing power and manufacturer-defined objectives;
a distribution module configured to recommend at least one distribution channel based on product and market data;
a benchmarking module configured to validate and refine the price and distribution strategy against historical benchmarks and product-market patterns using statistical analysis or anomaly detection techniques;
an output module configured to generate a report presenting the validated price, distribution strategy, key metrics and benchmarking insights to support market entry decisions;
wherein the platform operates autonomously upon receiving input from ingestion data module to generate a data-driven, market-specific strategy without requiring manual analysis or intervention.

2. The platform as claimed in claim 1, wherein the data ingestion module is configured to retrieve and normalize data from the plurality of data sources including product data, tariff and customs data, shipping and logistics data and distribution channel data.

3. The platform as claimed in claim 1, wherein the demand forecasting module employs a machine learning model selected from regression models, neural networks or decision trees to forecast demand.

4. The platform as claimed in claim 1, wherein the demand forecasting module utilizes historical sales data, macroeconomic indicators, seasonality trends and market segmentation data to predict demand for the product in the target market.

5. The platform as claimed in claim 1, wherein the price optimization module calculates the recommended retail price by combining landed cost with regional purchasing power indices, competitive pricing data and desired profit margins.

6. The platform as claimed in claim 1, wherein the price optimization module adjusts the recommended price based on the manufacturer's objective to maximize profit, enhance market penetration or position the product as a premium offering.

7. The platform as claimed in claim 1, wherein the distribution module selects the distribution strategy based on infrastructure, consumer behaviour and historical channel success in the target region.

8. The platform as claimed in claim 1, wherein the distribution module is configured to recommend distribution channels selected from local distributors, retail chains, e-commerce platforms or combinations thereof.

9. The platform as claimed in claim 1, wherein the benchmarking module compares the generated strategy against historical benchmarks using anomaly detection algorithms to identify outliers in price or distribution decisions.

10. The platform as claimed in claim 1, wherein the benchmarking module validates the strategy by referencing region-specific success rates, pricing tolerances and distribution channel performance metrics.

11. The platform as claimed in claim 1, wherein the report generated by the output module includes predictive metrics such as estimated first-quarter sales, projected market share and return on investment.

12. The platform as claimed in claim 1, wherein the output module presents the strategy report via a user interface or exportable file format incorporating charts, key performance indicators and scenario-based recommendations.

13. The platform as claimed in claim 1, wherein platform supports real-time re-evaluation of strategy when updated input data is received including tariff rate changes, logistics delays or inventory fluctuations.

14. A method for generating an international market entry strategy for a FMCG product, the method comprising:
ingesting and normalizing product, market and logistics data from multiple data sources;
forecasting demand in a target market using a machine learning model;
optimizing price based on landed cost, competitive pricing, consumer purchasing power and business objectives;
recommending distribution channels using product-market analysis and historical outcomes;
validating and outputting a market entry strategy report including pricing, distribution and benchmarking insights.

15. The method as claimed in claim 14, wherein ingesting and normalizing data includes retrieving standardized product information using GS1 or similar GTIN codes and mapping product categories to corresponding Harmonized System (HS) tariff codes.

16. The method as claimed in claim 14, wherein the optimizing price includes calculating the landed cost as a sum of manufacturing cost, shipping fees, import duties and customs clearance charges.

17. The method as claimed in claim 14, wherein validating the strategy includes comparing the optimized price and selected distribution channel against historical benchmarks using anomaly detection techniques to identify deviations from market norms.

18. The method as claimed in claim 14, wherein recommending distribution channels includes selecting at least one of the local distributors, e-commerce platforms or retail chains based on a machine learning model trained on historical market entry outcomes.

19. The method as claimed in claim 14, wherein the machine learning models used in the forecasting, pricing and distribution steps are dynamically updated based on new market data or feedback from past market entry outcomes.

20. The method as claimed in claim 14, wherein the output strategy report includes a projected sales volume and estimated profit margin for the recommended retail price and distribution channel in the target market.

21. A computer-implemented system for generating an international market entry strategy for a fast-moving consumer goods product, the computer-implemented system comprising:
a data acquisition module configured to retrieve data from a plurality of data sources including tariff data, regulatory requirements, logistics parameters, retail market intelligence and competitive landscape information;
a plurality of autonomous artificial intelligence agents, each agent configured to process a respective functional subset of the plurality of data sources;
an integration module configured to aggregate outputs from the autonomous artificial intelligence agents to form a unified market entry strategy; and
a user interface configured to present the market entry strategy with a plurality of actionable recommendations to a user;
wherein the system is operable to generate market entry strategy without human intervention after initial parameters are set.

22. The computer-implemented system as claimed in claim 21, wherein the autonomous artificial intelligence agents are trained on a proprietary dataset of over 650 historical FMCG market entry cases.
